(19) United States
(12) Patent Application Publication
(10) Pub. No.: US 2012/0001373 A1
(43) Pub. Date: Jan. 5, 2012

(54) SEGMENTED ELASTOMERIC VIBRATION MOUNT WITH EDGE CONTROL

(75) Inventor: Ronald J. McLaughlin, Fort Meyers, FL (US)

(73) Assignee: The Pullman Company, Milan, OH (US)

(21) Appl. No.: 12/826,766

(22) Filed: Jun. 30, 2010

(51) Int. Cl. F16F 7/00

(52) U.S. Cl. 267/141.1

(57) ABSTRACT

A mount assembly has a plurality of elastomeric members having a separator plate disposed between adjacent elastomeric members. The separator plate defines a flange which extends toward an adjacent separator plate to confine the elastomeric layer. A mounting plate is located at both ends of the mount assembly and can be used to attach the mount assembly to two components.

### FIELD

The present disclosure relates to a segmented elastomeric vibration mount. More particularly, the present disclosure relates to a segmented elastomeric vibration mount having edge control built into the plates disposed between the elastomeric layers.

### BACKGROUND

This section provides background information related to the present disclosure which is not necessarily prior art.

Mountings with both load bearing and deflection capabilities are used in applications such as vehicle suspensions, connecting an axle to a frame; earthquake isolation systems; machinery mounts; electrical equipment isolation; packaging; and other applications which require load bearing and deflection properties. These elastomeric mounts are designed to carry compressive and tensile loads while at the same time allowing the two components to translate and tilt relative to one another. Typically, an elastomeric mount uses recurring layers of an elastomeric material such as natural rubber mounted to separator plates. These designs of stacked elastomeric materials and separator plates allow the mount to have the same or similar lateral shear characteristics as a solid block of the elastomeric material. However, the capability of supporting a load in the vertical direction is enhanced with each additional segment added. This capability is characterized by the “shape factor” of the elastomeric design and this is a valuable tool in the design of isolation systems.

Stacking multiple layers of an elastomeric material and separator plates can create an expensive mount. Also, the weight of the mount increases as each layer is added. Most importantly, the load on the mount may not always be applied along the centerline of the vertical axis of the mount. When the load is applied at a position other than the centerline of the vertical axis of the mount, the edges of the layers of the elastomeric material are more highly compressed, resulting in higher stress in the elastomeric material. These higher stress levels can lead to a premature failure of the mount.

### SUMMARY

This section provides a general summary of the disclosure, and is not a comprehensive disclosure of its full scope or all of its features.

The present disclosure provides a mount which includes a stacked plurality of elastomeric materials and separator plates. The interlacing separator plates of the mount are formed to contain the rubber along the edges of the mount consistent with the overall pattern of the load application. Some or all of the edges of the plates are formed in a pattern to contain a portion of the elastomeric material. This engineered confinement of the edges of the elastomeric material concentrates stresses in the area of the mount that would be lightly loaded if the edges of the plate were not formed. The designer can increase the thickness of the segments while providing the same or similar spring rate and load capability. Conversely, the designer could reduce the number of segments, size and weight of the initial design to support a given load and vibration pattern.

The mount in the disclosure reduces the stresses at the edges of the elastomeric material by profiling the stress concentration. As a result, the mount becomes more durable when compared to current designs at the same loading pattern. Using the approach in this disclosure, the designer can either enhance the durability and load carrying capability of an existing package, or provide a lighter and more compact assembly as an initial proposal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a mount in accordance with the present disclosure;

FIG. 2 is a top plan view of the mount illustrated in FIG. 1;

FIG. 3 is a cross-sectional view taken in the direction 3-3 illustrated in FIG. 1;

FIG. 4 is a cross-sectional view taken in the direction 4-4 illustrated in FIG. 1;

FIG. 5 is a side view of one of the separator plates illustrated in FIG. 1;

FIG. 6 is a plan view of the separator plate illustrated in FIG. 5; and

FIG. 7 is a cross-sectional view taken in the direction 7-7 in FIG. 6.

Corresponding reference numerals indicate corresponding parts throughout the several views of the drawings.

### DETAILED DESCRIPTION

Example embodiments will now be described more fully with reference to the accompanying drawings.

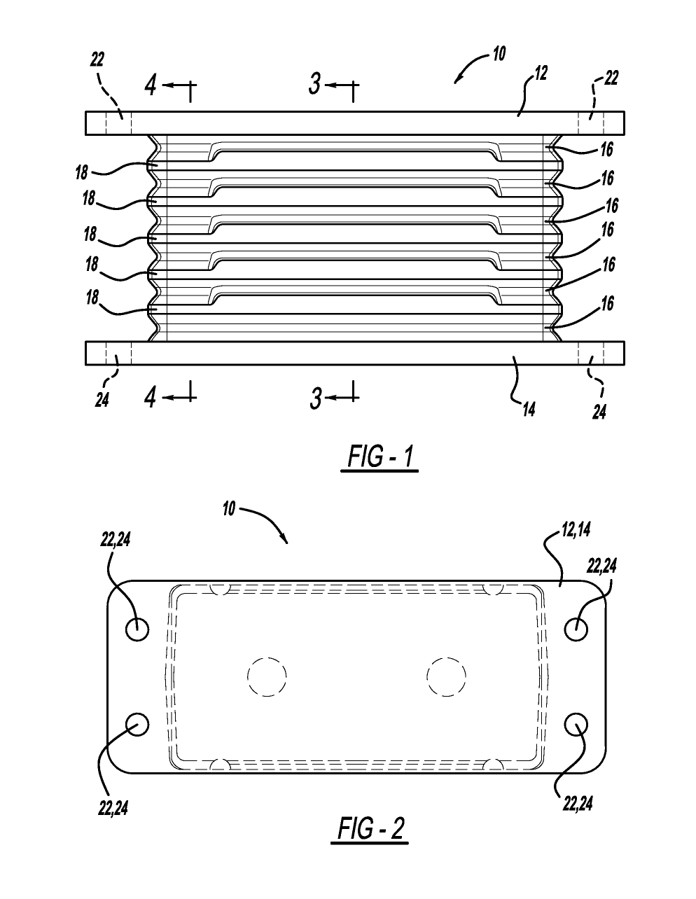

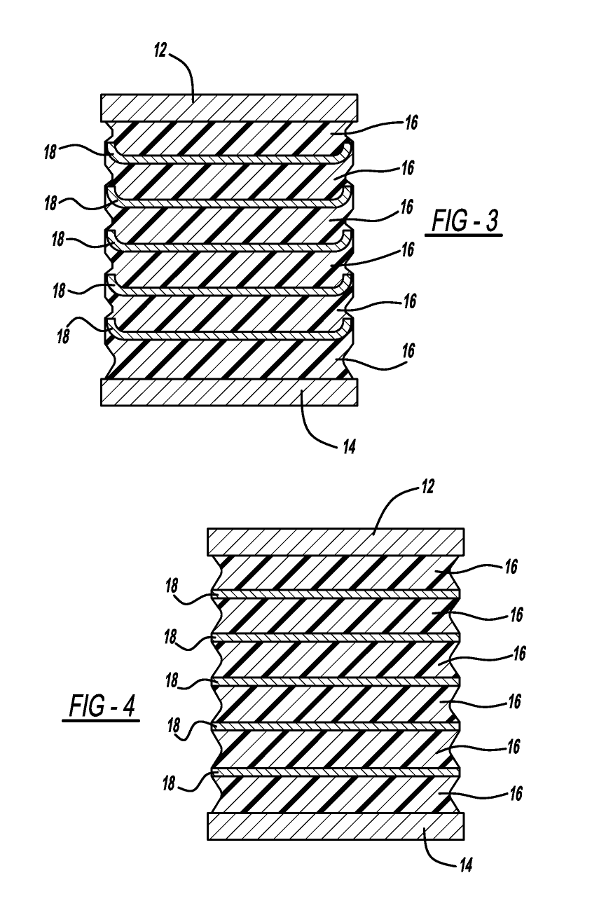

Referring to FIGS. 1-4, a mount assembly in accordance with the present disclosure is illustrated and is referred to generally by the reference numeral 10. Mount assembly 10 comprises a first mounting plate 12, a second mounting plate 14, a plurality of elastomeric layers 16 and a plurality of separator plates 18.

First mounting plate 12 is a generally rectangular plate having a plurality of mounting holes 22 extending through first mounting plate 12. Mount assembly 10 is designed to be placed between two components and the plurality of mounting holes 22 are provided to accept the appropriate fasteners to attach first mounting plate 12 to one of the two components. Second mounting plate 14 is a generally rectangular plate having a plurality of mounting holes 24 extending through second mounting plate 14. The plurality of mounting holes 24 are provided to accept the appropriate fasteners to attach second mounting plate 14 to the other of the two components. While first and second mounting plates 14 and 16 are provided with the plurality of mounting holes 22 and 24, respectively, it is within the scope of the present disclosure to use any method known in the art to attach first and second mounting plates 14 and 16 to the two components. Preferably, first and second mounting plates are metal components but first and second mounting plates 14 and 16 can be made from other material.

The plurality of elastomeric layers 16 and the plurality of separator plates 18 are alternately stacked between the first and second mounting plates 12 and 14 as illustrated in FIGS. 1, 3 and 4. Each of the plurality of elastomeric layers 16 have the same thickness and one of the elastomeric layers 16 is bonded to first mounting plate 12 and one of the elastomeric layers 16 is bonded to second mounting plate 14. While each of the plurality of elastomeric layers 16 are described as having the same thickness, it is within the scope of the present disclosure to have different thicknesses for the plurality of elastomeric layers 16.

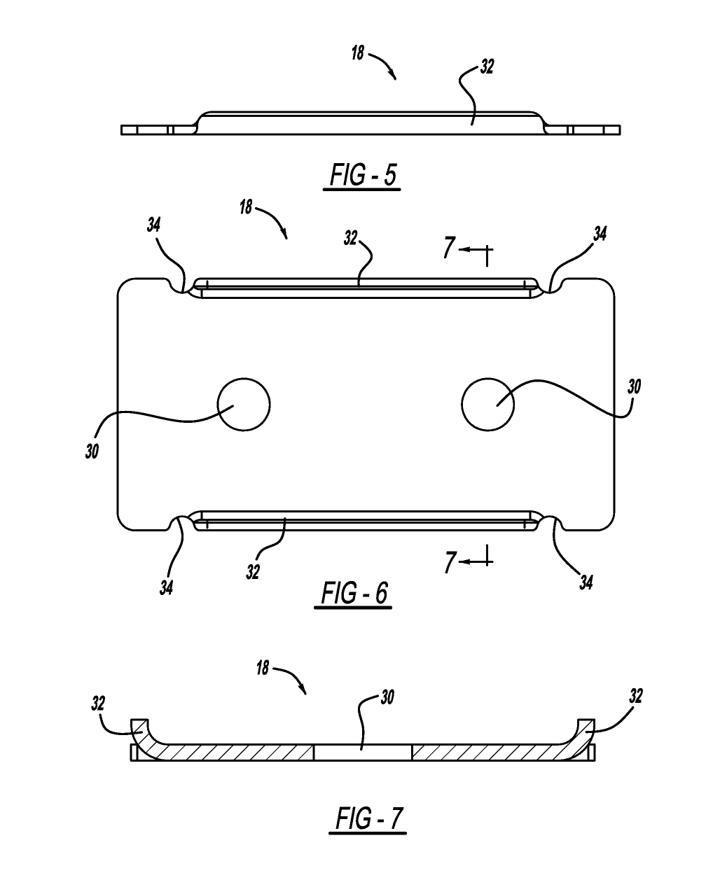

Each of the plurality of separator plates 18 is preferably a metal plate which is bonded to two of the plurality of elastomeric layers 16 as illustrated in FIGS. 1, 3 and 4. One of the plurality of elastomeric layers is bonded to an upper surface of separator plate 18 and one of the elastomeric layers 16 is bonded to a lower or opposite surface of separator plate 18. While separator plate 18 is illustrated as a metal plate, it is within the scope of this disclosure to use other materials for separator plate 18. As illustrated in FIGS. 5-7, each separator plate 18 is a generally rectangular plate defining a pair of through holes 30 and a pair of formed flanges 32. The pair of through holes 30 are disposed in a portion of separator plate 18 covered by elastomeric layer 16. Thus, during the molding of mount 10, elastomeric layer 16 will extend through the pair of through holes 30 to connect with the elastomeric layer 16 on the opposite side of separator plate 18.

One formed flange 32 is disposed along one of the long edges of rectangular separator plate 18 and one formed flange 32 is disposed along the other long edge of rectangular separator plate 18. While the two shorter edges of rectangular separator plate 18 do not include a formed flange 32, it is within the scope of the present disclosure to include formed flanges 32 on the short edges of rectangular separator plate 18. While all of the plurality of separator plates 18 in mount 10 are illustrated as having the same pair of formed flanges 32, it is within the scope of the present disclosure to have different lengths and/or heights of formed flanges 32 on one or more of the plurality of separator plates 18. Also, not all of the plurality of separator plates 18 need to include the pair of formed flanges 32 and only one side of any one or more of the plurality of separator plates 18 can not include formed flange 32. In addition, the length and/or height of the pair of formed flanges 32 on opposite sides of a single separator plate 18 do not have to be the same.

Each formed flange 32 is bent from the edge separator plate 18 toward an adjacent separator plate 18. A pair of notches 34 are formed at the ends of each formed flange 32 prior to the bending or forming of formed flange 32 to reduce the stress riser formed at the edges of formed flange 32. The length and height of each formed flange 32 is designed to confine the adjacent elastomeric layer 16 in a manner consistent with the overall pattern of the load application. This engineered confinement of the edges of elastomeric layer 16 concentrates the stresses toward the opposite side of mount assembly 10 which is an area that would be lightly loaded if formed flanges 32 were not provided. This reduces the stresses at the edges of elastomeric layers 16 and moves the stresses inward toward the center of mount assembly 10. The result is a profiled stress concentration that increases the durability and allows for the use of a reduced number of segments, a reduced size and a reduced weight for a given application.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A mount assembly comprising:
a first mounting plate;
a second mounting plate;
a plurality of elastomeric layers disposed between said first and second mounting plates; and
a plurality of separator plates disposed between said first and second mounting plates and between adjacent elastomeric layers, at least one separator plate defining a first formed flange extending along a first side of said at least one separator plate.

2. The mount assembly according to claim 1, wherein each of the plurality of separator plates is parallel with the other plurality of separator plates.

3. The mount assembly according to claim 1, wherein said at least one separator plate is a generally rectangular plate having two long sides and two short sides shorter than said long sides, said first side of said at least one separator plate being one of said two long sides.

4. The mount assembly according to claim 3, wherein a second formed flange extends along the other of said two long sides.

5. The mount assembly according to claim 4, wherein said first and second formed flanges extend along only said two long sides.

6. The mount assembly according to claim 5, wherein a length of each of said first and second formed flanges is less than a length of a respective long side.

7. The mount assembly according to claim 1, wherein a length of said first formed flange is less than a length of said first side.

8. The mount assembly according to claim 1, wherein said first formed flange extends toward an adjacent separator plate.

9. A mount assembly comprising:
a plurality of elastomeric layers;
a plurality of separator plates disposed between adjacent elastomeric layers, at least one of said plurality of separator plates defining a first formed flange extending along a first side of said at least one separator plate.

10. The mount assembly according to claim 9, wherein said at least one separator plate defines a second formed flange extending along a second side of said at least one separator plate, said second side being opposite to said first side.

11. The mount assembly according to claim 10, wherein said at least one separator plate is a rectangular plate having two long sides and two short sides shorter than said long sides, said first and second sides being said two long sides.

12. The mount assembly according to claim 11, wherein said first and second formed flanges extend along only said two long sides.

13. The mount assembly according to claim 11, wherein a length of each of said first and second formed flanges is less than a length of a respective long side.

14. The mount assembly according to claim 9, wherein a length of said first formed flange is less than a length of said first side.

15. The mount assembly according to claim 9, wherein each of the plurality of separator plates is parallel with the other plurality of separator plates.

16. The mount assembly according to claim 9, wherein said first formed flange extends toward an adjacent separator plate.

17. A mount assembly comprising:
a plurality of elastomeric layers;
a plurality of separator plates disposed between adjacent elastomeric layers, each of said plurality of separator plates defining a first formed flange extending along a first side of said separator plate.

18. The mount assembly according to claim 17, wherein each of said separator plates defines a second formed flange extending along a second side of said separator plate, said second side being opposite to said first side.

19. The mount assembly according to claim 18, wherein each of said separator plates is a rectangular plate having two long sides and two short sides shorter than said long sides, said first and second sides being said two long sides.

20. The mount assembly according to claim 19, wherein said first and second formed flanges extend along only said two long sides.
